(19) United States
(12) Patent Application Publication
(10) Pub. No.: US 2025/0023298 A1
(43) Pub. Date: Jan. 16, 2025

(54) ELECTRICAL CONNECTOR ASSEMBLY

(71) Applicant: Lear Corporation, Southfield, MI (US)

(72) Inventors: Ümit Celiker, Remscheid (DE); Xavier Farre Vives, Valls (ES); Luis Miguel Munoz Garcia, Valls (ES)

(73) Assignee: Lear Corporation, Southfield, MI (US)

(21) Appl. No.: 18/748,472

(22) Filed: Jun. 20, 2024

(30) Foreign Application Priority Data
Jul. 10, 2023 (DE) 102023118161.0

(51) Int. Cl. H01R 13/641; H01R 13/627; H01R 13/629

(52) U.S. Cl. CPC H01R 13/641; H01R 13/6275; H01R 13/62916

(57) ABSTRACT

An electrical connector assembly with a connector body, a slider, and a connector position assurance (CPA) element. The connector body has a CPA engagement recess. The slider has spaced apart side walls configured to operatively engage and telescopically slide longitudinally relative to the connector body and an end wall. The end wall including a CPA cavity configured to be aligned with and located adjacent to the CPA engagement recess when the end wall is located in a fully seated position adjacent to the connector body. The CPA element retained by and longitudinally slidable with the slider and telescopically slidable in a lateral direction relative to the CPA cavity. The CPA element has a catch configured to operatively engage the CPA engagement recess when the end wall is in the fully seated position and the CPA element is laterally slid into the CPA cavity into a final lock position.

### FIELD

This disclosure relates to an electrical connector assembly, and more particularly to an electrical connector assembly with a connector position assurance element.

### BACKGROUND

Electrical connector pairs are known that provide convenient and quick electrical connections. Some electrical connector pairs can be connected using hand insertion, with a human hand readily being able to provide enough force for insertion. Some electrical connector pairs employ a pivotable lever to assist with insertion when hand applied mating insertion force may not be generally sufficient during insertion of one connector into the other. Some electrical connector pairs may employ a slide to assist in bringing the electrical connector pair into engagement when engagement assist is desirable but packaging, wire routing or other constraints make a lever type of engagement assist impracticable.

Other types of electrical connector pairs employ a connector position assurance (CPA) element that locks a connector body in place for hand-inserted connectors and locking an engagement lever in a fixed position for connectors having an engagement lever. This prevents unexpected disconnection of the electrical connector pairs.

### SUMMARY

According to an aspect, the disclosure provides an electrical connector assembly including a connector body including a CPA engagement recess; a slider including spaced apart side walls configured to operatively engage and telescopically slide longitudinally relative to the connector body and an end wall operatively engaging the side walls so that the end wall is slidable toward the connector body, with the end wall including a CPA cavity configured to be aligned with and located adjacent to the CPA engagement recess when the end wall is located in a fully seated position adjacent to the connector body; and a CPA element retained by and longitudinally slidable with the slider and telescopically slidable in a lateral direction relative to the CPA cavity, the CPA element including a catch configured to operatively engage the CPA engagement recess when the end wall is in the fully seated position and the CPA element is laterally slid into the CPA cavity into a final lock position.

According to an aspect, the disclosure provides an electrical connector assembly including: a connector body including a CPA engagement recess; a slider including spaced apart side walls configured to operatively engage and telescopically slide longitudinally relative to the connector body and an end wall operatively engaging the side walls so that the end wall is slidable toward the connector body, with the end wall including a CPA cavity configured to be aligned with and located adjacent to the CPA engagement recess when the end wall is located in a fully seated position adjacent to the connector body, the CPA cavity including barb catches extending within the CPA cavity; and a CPA element retained by and longitudinally slidable with the slider, the CPA element including a catch configured to operatively engage the CPA engagement recess when the end wall is in the fully seated position and the CPA element is slid into the CPA cavity into a final lock position and a pair of flexible legs, each having a barb extending therefrom configured to operatively engage the corresponding barb catches extending within the CPA cavity to retain the CPA element within the CPA cavity when the CPA element is in a pre-lock position.

According to an aspect, the disclosure provides a connector position assurance (CPA) function while employing a slider for insertion assist, thus minimizing packaging space and allowing for certain orientations of wire routing. According to an aspect, the disclosure provides the CPA function while a CPA element does not add to overall connector volume when in a locked position. According to an aspect, the disclosure provides the CPA element integrated into a slider.

Various aspects of an electrical connector assembly will become apparent to those skilled in the art from the following detailed description of the embodiments, when read in light of the accompanying drawings.

### BRIEF DESCRIPTION OF THE DRAWINGS

FIG. 1 is a schematic, perspective view of an electrical connector assembly, with a slider in an open position and a connector position assurance (CPA) element in a pre-lock position.

FIG. 2 is a schematic, plan view of the electrical connector of FIG. 1.

FIG. 3 is a schematic, section view taken along line 3-3 in FIG. 2.

FIG. 4 is a schematic, section view taken along line 4-4 in FIG. 2.

FIG. 5 is a schematic, perspective view of the slider.

FIG. 6 is a schematic, section view taken along line 6-6 in FIG. 5.

FIG. 7 is a schematic, perspective view of the CPA element.

FIG. 8 is a schematic, side view of the CPA element.

FIG. 9 is a schematic, end view of the CPA element.

FIG. 10 is a schematic, perspective view similar to FIG. 1, but with the slider in a fully seated position and a portion of a second connector mounted to the connector body.

FIG. 11 is a schematic, section view taken along line 11-11 in FIG. 10.

FIG. 12 is a schematic view, on an enlarged scale, of the encircled area 12 in FIG. 11.

FIG. 13 is a schematic, perspective view similar to FIG. 1, but with the slider in the fully seated position and the CPA element in a locked position and a portion of a second connector mounted to the connector body.

FIG. 14 is a schematic, section view taken along line 14-14 in FIG. 13.

FIG. 15 is a schematic view, on an enlarged scale, of encircled area 15 in FIG. 14.

### DETAILED DESCRIPTION

Referring now to an example shown in the drawings, there is illustrated an electrical connector assembly 20, which includes a connector body 22. The connector body 22 includes a pair of slider recesses 24 on opposed sides 26 of the connector body 22, with the slider recesses 24 extending in a longitudinal direction 28. The longitudinal direction 28 is indicted by the arrow 28 in the Figures, while a lateral direction 30 is indicated by the arrow 30 in the Figures. The connector body 22 also includes a CPA engagement recess 32 located on an end 34 of the connector body 22, between the slider recesses 24. The CPA engagement recess 32 includes a retention wall 36 located within the recess 32.

In this example illustrated in the drawings, the electrical connector assembly 20 includes a slider 38 having a pair of longitudinally extending side walls 40 connected by an end wall 42. Each of the side walls 40 are sized and spaced to telescopically slide into a respective one of the slider recesses 24, allowing for the slider 38 to telescopically slide into the connector body 22. Each of the side walls 40 includes a pair of cam slots 44 recessed into surfaces facing the other of the side walls 40, with each of the cam slots 44 extending from an edge 46 of its respective side wall 40 angled in a lateral and longitudinal direction toward the end wall 42. The end wall 42 includes a CPA cavity 48 having a pair of opposed laterally extending walls 50, which each have a barb 52 that extends into the CPA cavity 48. The CPA cavity 48 is sized and shaped to telescopically receive a CPA element 54.

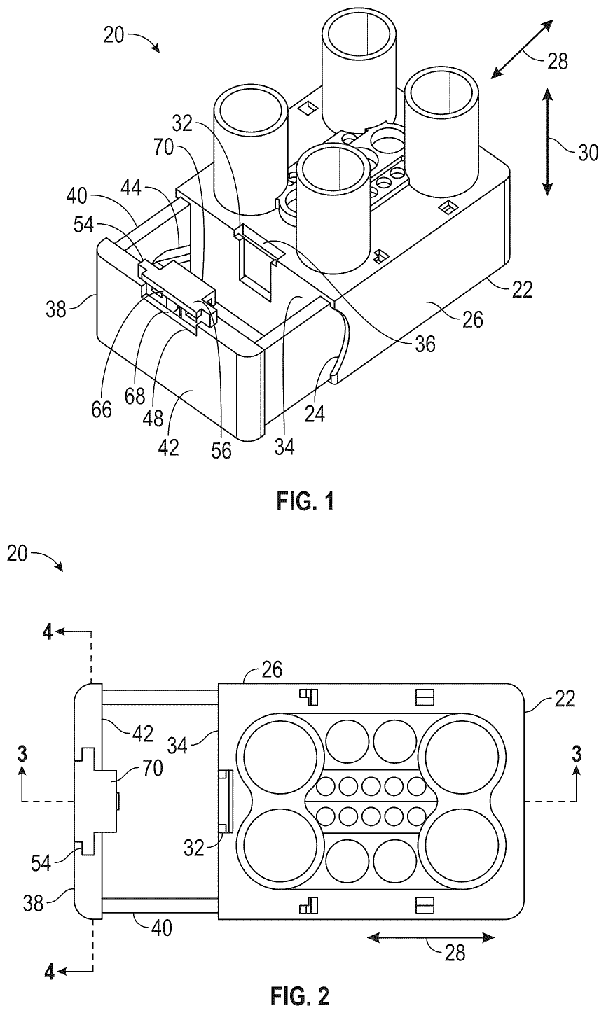

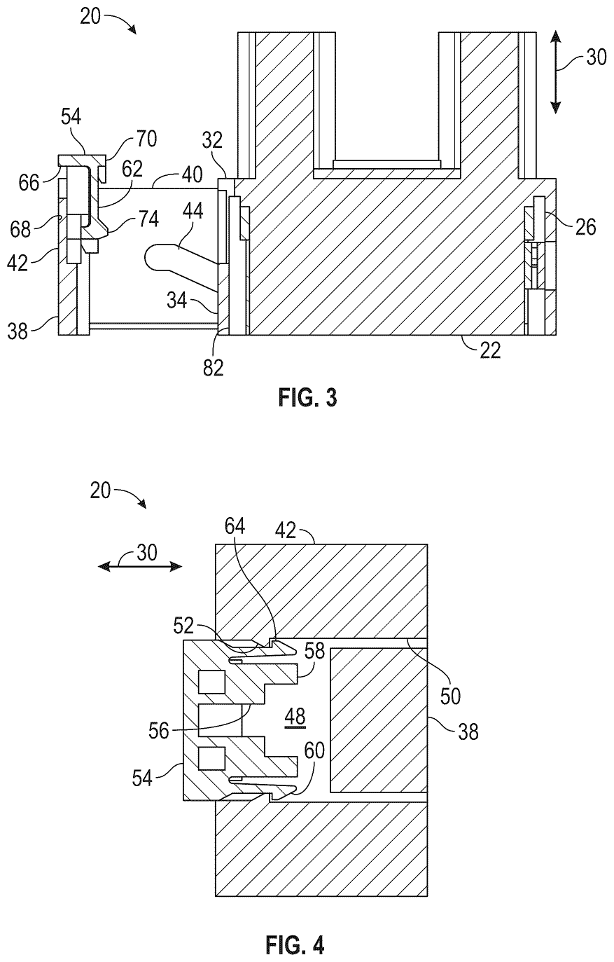

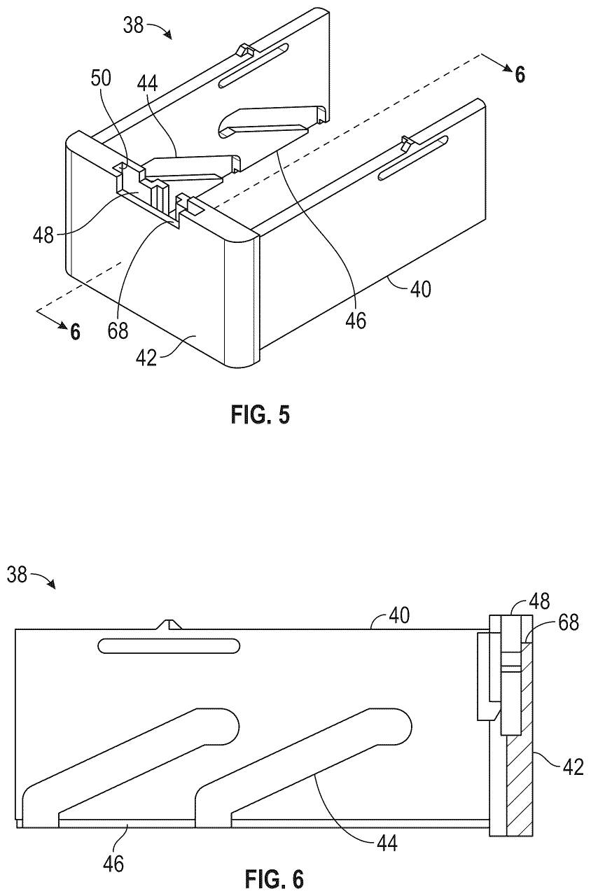

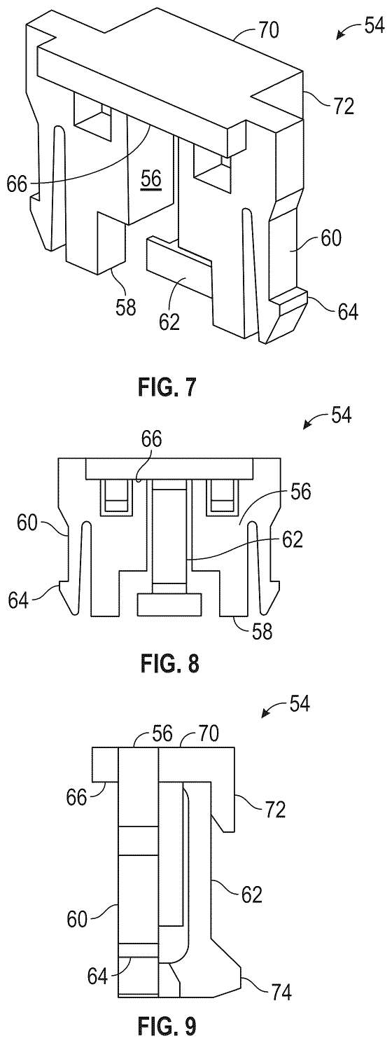

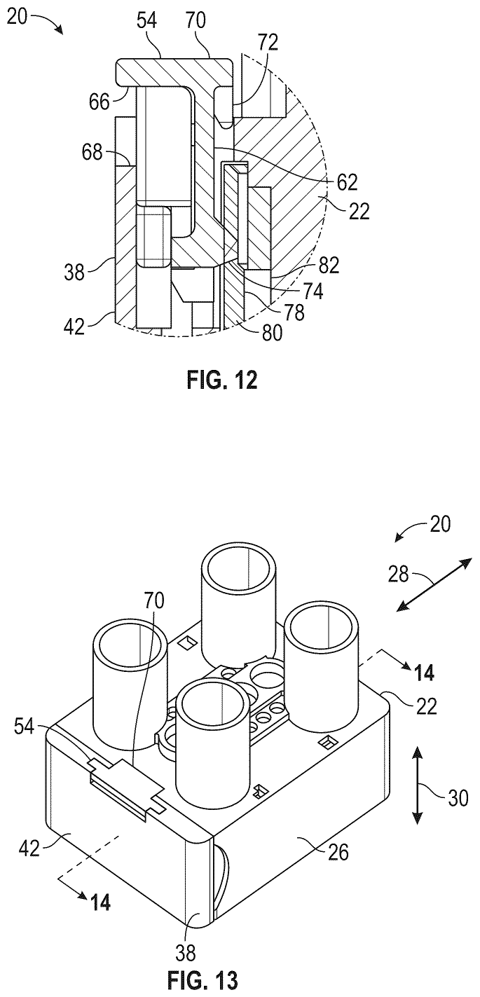

In this example illustrated in the drawings, the CPA element 54 includes a main body 56, from which a pair of laterally extending central legs 58, a pair of laterally extending flexible legs 60, and an elastically flexible engagement leg 62, extend. The central legs 58 are spaced apart, allowing for a portion of the engagement leg 62 to elastically flex between the central legs 58. The flexible legs 60 each include a barb 64 extending toward a respective one of the barbs 52 and engage the main body 56 to allow for elastic flexing of the flexible legs 60. Accordingly, when the CPA element 54 is partially telescopically inserted into the CPA cavity 48, the barbs 64 will engage and slide past their respective barbs 52 as the flexible legs 60 are flexed and then spring back upon the respective barbs just passing each other. At this point, the CPA element 54 is retained in the CPA cavity 48 in a pre-lock position. The pre-lock position of the CPA element 54 is illustrated in FIGS. 1-4 and 10-12, which is a position where the CPA element 54 is retained by the slider 38 but not in a final lock position.

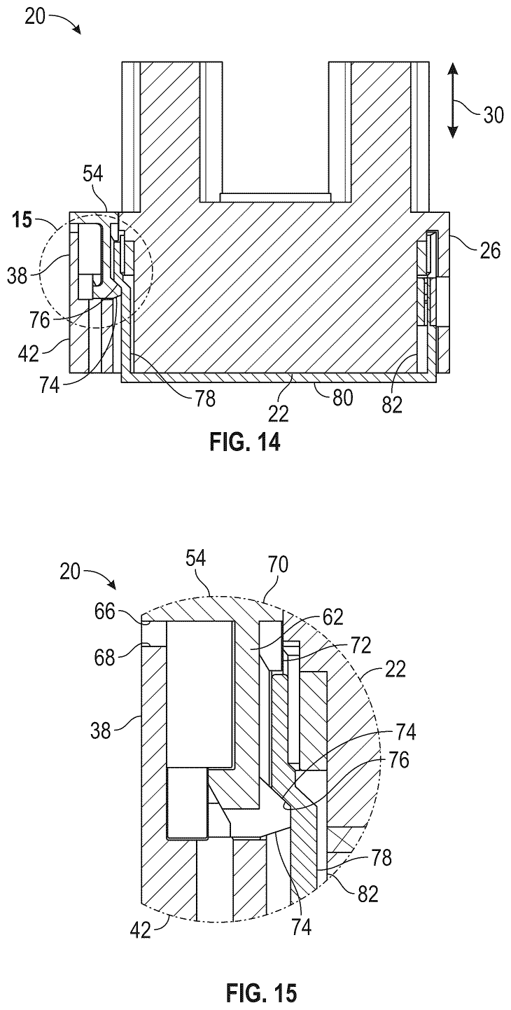

In this example illustrated in the drawings, the CPA element 54 includes a longitudinally extending stop 66 configured to engage with a stop portion 68 of the CPA cavity 48 in the end wall 42. As the CPA element 54 is moved from the pre-lock position (see FIGS. 1-4 and 10-12) to a final lock position (see FIGS. 13-15), stop 66 may abut the stop portion 68, stopping any further lateral movement of the CPA element 54. The final lock position for the CPA element 54 is a position where the CPA element 54 prevents the slider 38 from sliding longitudinally away from the connector body 22.

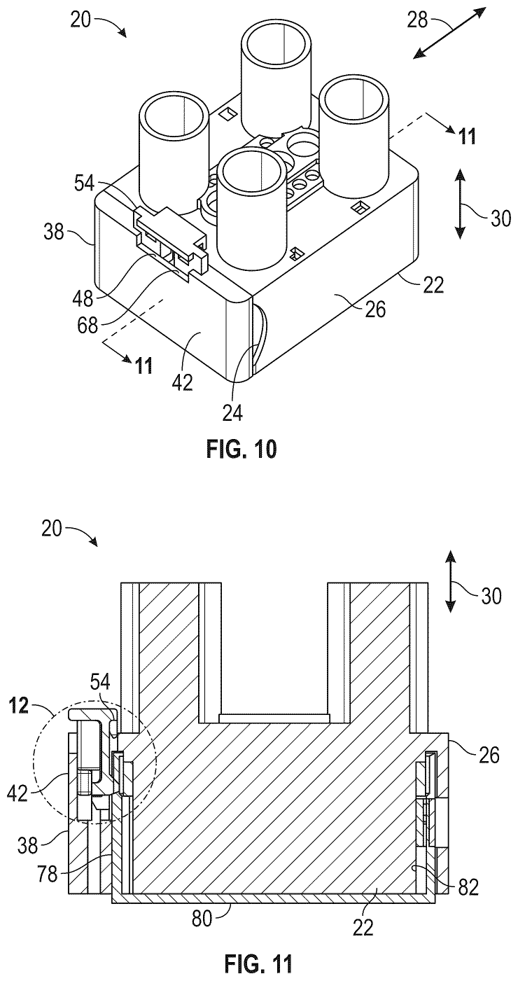

In this example illustrated in the drawings, the CPA element 54 includes a longitudinally extending flange 70 extending from the main body 56 toward the CPA engagement recess 32, and a laterally extending catch 72 extending from the flange 70. The flange 70 and catch 72 are sized and located so that, when the CPA element is in the pre-lock position and the slider 38 is slid longitudinally from an open position (see FIGS. 1-4) to a fully seated position (see FIGS. 10-12), the flange 70 and catch 72 do not contact the connector body 22. The fully seated position is a position where the end wall 42 of the slider 38 is moved longitudinally adjacent to (and possibly in contact with) the connector body 22. The flange 70 and catch 72 are also sized and located so that, when the slider 38 is in the fully seated position (see FIGS. 10-12), as the CPA element 54 is slid laterally from the pre-lock position (see FIGS. 10-12) to the final lock position (see FIGS. 13-15), the catch 72 slides into the CPA engagement recess 32 along the retention wall 36. In this final lock position, the catch 72 engages the retention wall 36 to prevent the slider 38 from being slid longitudinally away from the connector body 22.

In this example illustrated in the drawings, the CPA element 54 includes a retainer 74 that extends in the longitudinal direction from the engagement leg 62. The retainer 74 is configured to mate with a retention notch 76 in a wall 78 of a second connector 80 when the CPA element 54 is slid in the lateral direction into its final lock position after the wall 78 is slid into a channel 82 in the connector body 22. The mating of the retainer 74 in the retention notch 76 holds the CPA element 54 in the final lock position, thus restricting lateral movement of the CPA element 54 relative to the connector body 22.

An example of the operation of the electrical connector assembly 20 will now be discussed with reference to the example illustrated in the Figures. With the slider 38 and CPA element 54 in the position shown in FIGS. 1-4, the wall 78 of the second connector 80 is aligned with the corresponding channel 82 in the connector body and the second connector 80 is engaged with the cam slots 44. The slider 38 is then slid longitudinally (direction 28) toward the connector body 22, with the side walls 40 telescopically sliding into respective slider recesses 24 until the slider 38 is in the fully seated position shown in FIGS. 10-12. As the slider 38 is slid longitudinally toward the connector body 22, the angle of the cam slots 44 pulls the second connector 80 toward the connector body, pushing the wall 78 into the channel 82 and connecting the pair of connectors. The CPA element 54 is then telescopically slid laterally (direction 30) into the CPA cavity 48 of the end wall 42 until the CPA element 54 is in the final lock position as shown in FIGS. 13-15. As the CPA element 54 is slid into the CPA cavity 48, the catch 72 engages the CPA engagement recess 32 to prevent the slider 38 from sliding away from the connector body 22, and the retainer 74 engages the retention notch 76 in the wall 78 of the second connector 80 to prevent the second connector 80 from moving away from the connector body 22. In the final lock position, the main body 56 of the CPA element 54 is flush with an outer surface of the connector body 22 and an outer surface of the end wall 42 of the slider 38, thus no additional packaging space is used by the CPA element 54, minimizing overall package space taken by the electrical connector assembly 20.

The principle and mode of operation of the electrical connector assemblies described herein have been explained and illustrated as example embodiments. However, it must be understood that an electrical connector assembly may be practiced otherwise than as specifically explained and illustrated without departing from its spirit or scope.

What is claimed is:

1. An electrical connector assembly comprising:
a connector body including a CPA engagement recess;
a slider including spaced apart side walls configured to operatively engage and telescopically slide longitudinally relative to the connector body and an end wall operatively engaging the side walls so that the end wall is slidable toward the connector body, with the end wall including a CPA cavity configured to be aligned with and located adjacent to the CPA engagement recess when the end wall is located in a fully seated position adjacent to the connector body; and
a CPA element retained by and longitudinally slidable with the slider and telescopically slidable in a lateral direction relative to the CPA cavity, the CPA element including a catch configured to operatively engage the CPA engagement recess when the end wall is in the fully seated position and the CPA element is laterally slid into the CPA cavity into a final lock position.

2. The electrical connector assembly of claim 1 wherein the CPA element includes a retainer on an elastically flexible engagement leg configured to engage a retention notch on a second connector to hold the second connector in engagement with the connector body.

3. The electrical connector assembly of claim 2 wherein the CPA element includes a pair of flexible legs, each having a barb extending therefrom configured to operatively engage corresponding barb catches extending within the CPA cavity to retain the CPA element within the CPA cavity.

4. The electrical connector assembly of claim 3 wherein each of the side walls of the slider include a cam slot configured to mate with the second connector to pull the second connector into engagement with the connector body when the slider is moved longitudinally toward the connector body.

5. The electrical connector assembly of claim 2 wherein each of the side walls of the slider includes a cam slot configured to mate with the second connector to pull the second connector into engagement with the connector body when the slider is moved longitudinally toward the connector body.

6. The electrical connector assembly of claim 5 wherein the CPA element includes a main body that is flush with an outer surface of the connector body when the CPA element is in the final lock position.

7. The electrical connector assembly of claim 2 wherein the CPA element includes a main body that is flush with an outer surface of the connector body when the CPA element is in the final lock position.

8. The electrical connector assembly of claim 2 wherein the CPA engagement recess includes a retention wall configured to operatively engage the catch of the CPA element when the CPA element is in the final lock position.

9. The electrical connector assembly of claim 1 wherein the CPA engagement recess includes a retention wall configured to operatively engage the catch of the CPA element when the CPA element is in the final lock position.

10. The electrical connector assembly of claim 1 wherein the CPA element includes a pair of flexible legs, each having a barb extending therefrom configured to operatively engage corresponding barb catches extending within the CPA cavity to retain the CPA element within the CPA cavity.

11. The electrical connector assembly of claim 1 wherein each of the side walls of the slider include a cam slot configured to mate with a second connector to pull the second connector into engagement with the connector body when the slider is moved longitudinally toward the connector body.

12. The electrical connector assembly of claim 1 wherein the CPA element includes a main body that is flush with an outer surface of the connector body when the CPA element is in the final lock position.

13. An electrical connector assembly comprising:
a connector body including a CPA engagement recess;
a slider including spaced apart side walls configured to operatively engage and telescopically slide longitudinally relative to the connector body and an end wall operatively engaging the side walls so that the end wall is slidable toward the connector body, with the end wall including a CPA cavity configured to be aligned with and located adjacent to the CPA engagement recess when the end wall is located in a fully seated position adjacent to the connector body, the CPA cavity including barb catches extending within the CPA cavity; and
a CPA element retained by and longitudinally slidable with the slider, the CPA element including a catch configured to operatively engage the CPA engagement recess when the end wall is in the fully seated position and the CPA element is slid into the CPA cavity into a final lock position and a pair of flexible legs, each having a barb extending therefrom configured to operatively engage the corresponding barb catches extending within the CPA cavity to retain the CPA element within the CPA cavity when the CPA element is in a pre-lock position.

14. The electrical connector assembly of claim 13 wherein the CPA element includes a retainer on an elastically flexible engagement leg configured to engage a retention notch on a second connector to hold the second connector in engagement with the connector body.

15. The electrical connector assembly of claim 13 wherein the CPA engagement recess includes a retention wall configured to operatively engage the catch of the CPA element when the CPA element is in the final lock position.

16. The electrical connector assembly of claim 13 wherein each of the side walls of the slider include a cam slot configured to mate with a second connector to pull the second connector into engagement with the connector body when the slider is moved longitudinally toward the connector body.

17. The electrical connector assembly of claim 13 wherein the CPA element includes a main body that is flush with an outer surface of the connector body when the CPA element is in the final lock position.

18. An electrical connector assembly comprising:
a connector body including a CPA engagement recess, the CPA engagement recess including a retention wall;
a slider including spaced apart side walls configured to operatively engage and telescopically slide longitudinally relative to the connector body and an end wall operatively engaging the side walls so that the end wall is slidable toward the connector body, with the end wall including a CPA cavity configured to be aligned with and located adjacent to the CPA engagement recess when the end wall is located in a fully seated position adjacent to the connector body; and
a CPA element retained by and longitudinally slidable with the slider and telescopically slidable in a lateral direction relative to the CPA cavity, the CPA element including a catch configured to operatively engage the CPA engagement recess when the end wall is in the fully seated position and the CPA element is laterally slid into the CPA cavity into a final lock position, the CPA element including a main body that is flush with an outer surface of the connector body when the CPA element is in the final lock position;
wherein the retention wall is configured to operatively engage the catch of the CPA element when the CPA element is in the final lock position.

19. The electrical connector assembly of claim 18 wherein the CPA element includes a retainer on an elastically flexible engagement leg configured to engage a retention notch on a second connector to hold the second connector in engagement with the connector body.

20. The electrical connector assembly of claim 18 wherein the CPA element includes a pair of flexible legs, each having a barb extending therefrom configured to operatively engage corresponding barb catches extending within the CPA cavity to retain the CPA element within the CPA cavity.
